(19) United States
(12) Patent Application Publication
(10) Pub. No.: US 2013/0141308 A1
(43) Pub. Date: Jun. 6, 2013

(54) ELECTRONIC DEVICE AND MULTI-PANEL INTERFACE DISPLAYING METHOD

(71) Applicants: Yi-Shu HUANG, New Taipei City (TW); Yun-Wei LIAO, Guishan Township (TW); Chih-Hao HSU, Taipei City (TW)

(72) Inventors: Yi-Shu HUANG, New Taipei City (TW); Yun-Wei LIAO, Guishan Township (TW); Chih-Hao HSU, Taipei City (TW)

(73) Assignee: INSTITUTE FOR INFORMATION INDUSTRY, Taipei (TW)

(21) Appl. No.: 13/488,152

(22) Filed: Jun. 4, 2012

(30) Foreign Application Priority Data
Dec. 1, 2011 (TW) 100144115

(51) Int. Cl. G09G 5/00

(52) U.S. Cl. 345/2.1

(57) ABSTRACT

An electronic device supporting multi-panel interface displaying is provided. The electronic device has: a processing unit configured to provide an operating interface, wherein the operating interface has a plurality of interface components; and a multi-device group communication unit configured to perform a device coordination process between the electronic device and at least one other electronic device, wherein the at least one other electronic device has a corresponding processing unit and a corresponding multi-device group communication unit, and the processing unit adjusts at least one of the interface components displayed on the electronic device according to a number of devices in the device coordination process between the electronic device and the at least one other electronic device.

### CROSS REFERENCE TO RELATED APPLICATIONS

This application claims priority of Taiwan Patent Application No. 100144115, filed on Dec. 1, 2011, the entirety of which is incorporated by reference herein.

### BACKGROUND OF THE INVENTION

1. Field of the Invention

The present invention relates to an electronic device supporting a multi-panel interface and a multi-panel displaying method, and in particular relates to an electronic device and a multi-panel displaying method applied in multiple electronic devices for supporting an application to display various interface components on multiple panels on the multiple electronic devices, respectively, to perform a device coordination process.

2. Description of the Related Art

As the development of technology continues, mobile devices are being popularly used, especially such as smart phones, tablet PCs, netbooks, and laptops. Due to design considerations for communications and convenience of portability, smaller sized display panels are usually used in mobile devices. Because of the limited display area of these display panels, there are many limitations for user interfaces, such as smaller display size, simplified menus, fewer functions, inconvenient display for multi-panel, thereby causing trouble during operations by users. In addition, since the specifications and operating systems of the portable devices may vary, these portable devices usually can not be united. When a user owns multiple portable devices, these portable devices can not be united and the usage experiences is not good for user. Therefore, there is demand for an electronic device and a multi-panel displaying method supporting multi-panel interfaces. The united display and the united operation between multiple portable devices (e.g. tablet PCs, or smart phones) can provide expanded usage experiences.

### BRIEF SUMMARY OF THE INVENTION

A detailed description is given in the following embodiments with reference to the accompanying drawings.

In an exemplary embodiment, an electronic device supporting multi-panel interface displaying is provided. The electronic device has: a processing unit configured to provide an operating interface, wherein the operating interface comprises a plurality of interface components; and a multi-device group communication unit configured to perform a device coordination process between the electronic device and at least one other electronic device, wherein the at least one other electronic device has a corresponding processing unit and a corresponding multi-device group communication unit, wherein the processing unit adjusts at least one of the interface components displayed on the electronic device according to a number of devices in the device coordination process between the electronic device and the at least one other electronic device.

In another exemplary embodiment, a multi-panel interface displaying method applied in an electronic device supporting multi-panel interface displaying is provided. The method comprises the following steps of: using a processor to execute the following steps of: providing an operating interface, wherein the operating interface comprises a plurality of interface components; performing a device coordination process between the electronic device and at least one other electronic device; and adjusting at least one of the interface components displayed on the electronic device according to a number of devices in the device coordination process between the electronic device and the at least one other electronic device.

### BRIEF DESCRIPTION OF THE DRAWINGS

The present invention can be more fully understood by reading the subsequent detailed description and examples with references made to the accompanying drawings, wherein:

FIG. 1A illustrates a block diagram of the electronic device according to the first embodiment of the invention;

FIG. 1B illustrates a block diagram of the electronic device according to the second embodiment of the invention;

FIG. 2A illustrates a diagram of group communications between multiple electronic devices according to the third embodiment of the invention;

FIG. 2B illustrates a diagram of group communications between multiple electronic devices according to the fourth embodiment of the invention;

FIGS. 3A-3C illustrate diagrams of the operating interface supporting multiple panels according to the fifth embodiment of the invention;

FIGS. 4A-4D illustrate diagrams of the way of displaying the operating interface according to the sixth embodiment of the invention;

FIGS. 5A-5C illustrate diagrams of the way of displaying the operating interface according to the seventh embodiment of the invention; and

FIG. 6 illustrates a flow chart of the multi-panel interface displaying method according to an embodiment of the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims. The multiple panels described in the following embodiments may indicate displays of multiple electronic devices, and the multi-panel interface may indicate a portion of or whole interface components of the operation interface displayed on the displays of the multiple electronic devices.

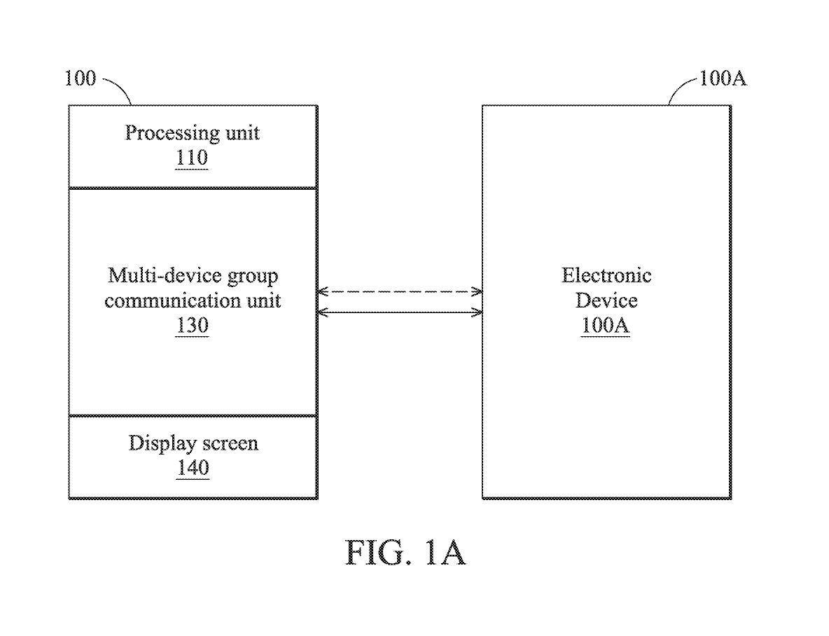

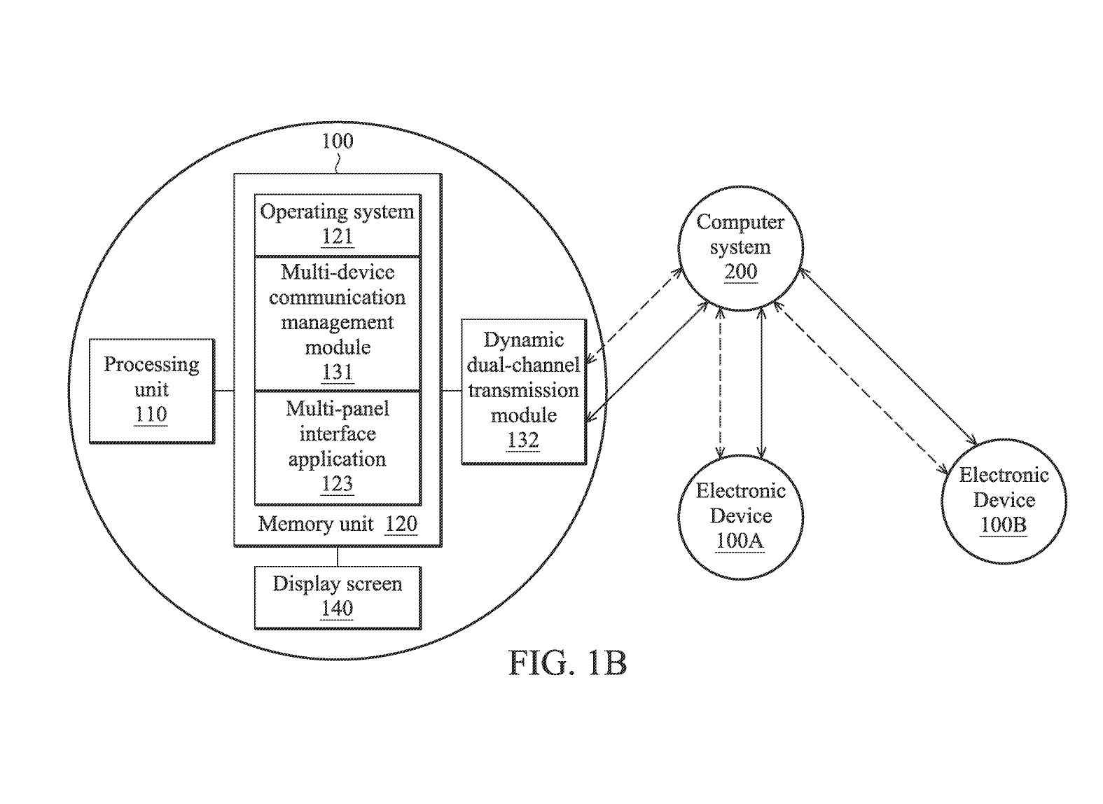

FIG. 1A illustrates a block diagram of an electronic device according to the first embodiment of the invention. The electronic device 100 can be a device with communication functions, such as personal computers, notebooks, netbooks, or tablet PCs, etc, but the invention is not limited thereto. The electronic device 100 may primarily comprises a processing unit 110, a multi-device group communication unit 130, and a display panel 140. The multi-device group communication unit 130 is configured to perform the device coordination process between the electronic device 100 and other electronic devices. The processing unit 110 may provide an operation interface comprising a plurality of interface components. The processing unit 110 may adjust the portion of or all of the interface components of the operation interface displayed on the display screen 140 of the electronic device 100 according to a number of devices in the device coordination process (e.g. the number of devices with which the electronic device 100 performs the device coordination process). The number of other electronic devices can be at least one, such as the electronic device 100A. Each electronic device may also have a corresponding processing unit, multi-device group coordination unit, and display screen.

The processing unit 110 can be implemented by a particular processor with a specific logic circuit, or implemented by a central processing unit reading the multi-interface application. In the embodiment by using a common central processing unit reading the multi-interface application, the multi-interface application can be stored in a memory unit (not shown in FIG. 1A), wherein the memory unit can be a non-volatile memory (e.g. ROM, hard disks, etc.), or a volatile memory (e.g. SRAM, DRAM, etc.). The processing unit 110 may read and execute the multi-interface application stored in the memory unit to provide an operation interface on the electronic device 100, and adjust the interface components displayed by the electronic device 100.

FIG. 1B illustrates a block diagram of the electronic device according to the second embodiment of the invention. In this embodiment, the electronic device 100 may perform the device coordination process with other electronic devices through a computer system 200. In the embodiment, the multi-device group communication unit may further comprise a multi-device management module 131 and a dynamic dual-channel transmission module 132. The multi-device management module 131 can be an application to manage the communications between the electronic device 100 and the computer system 200, which communicates with other electronic devices (e.g. electronic device 100A and 100B) through the computer system 200 to perform the device coordination process between the electronic device 100 and the other electronic devices 100A and 100B. The dynamic dual-channel transmission module 132 is configured to dynamically transmit data in two different properties by using two transmission channels, respectively. For example, the dynamic dual-channel transmission module 132 may transmit time-sensitive emergency messages or control signals from the first transmission channel, and transmit common data or a large amount of video/audio data from the second transmission channel. It can provide a transmission way with flexibility to avoid delay of the time-sensitive messages caused by the transmission of a large amount of data. In an embodiment, the dynamic dual-channel transmission module 132 can be implemented by software with a network interface, wherein the dual channels can be two socket connections for example. Also, the computer system 200 and the electronic device 100A and 100B may also have their own corresponding processing unit, memory unit, multi-device group communication unit, and display panel.

In another embodiment of the implementation of a common CPU reading an application stored in the memory unit 120, the memory unit 120 may store an operating system 121, a multi-device communication management module 131, and the multi-panel interface application 123. The processing unit 110 may execute the operating system 121 as a processing platform, which can be further used to execute the multi-device group communication management module 131 and the multi-panel interface application 123. For example, the operating system 121 can be Android, iOS, Linux, or Windows, etc. The multi-device communication management module 131 can be an application to perform the communications between multiple electronic devices to reduce the communication time of the group communication process when the multiple electronic devices are coordinating with each other. In the embodiment of performing communications between multiple electronic devices through the computer system 200, the multi-device communication management module 131 may further detect whether the computer system 200 exists in the local network of the electronic device 100. When the computer system 200 exists in the local network of the electronic device 100, the processing unit 110 of the electronic device 100 may connect to other electronic devices (e.g. electronic device 100A and 100B) in the local network to perform the device coordination process through the computer system 200, and obtain a number of devices in the device coordination process from the computer system 200.

The operating interface provided by the processing unit 110 may comprise a plurality of interface components, such as extendable interface components. When the electronic device 100 performs a device coordination process with other electronic devices, the processing unit 110 may perform multi-panel displaying according to the properties of display panels of different electronic devices, such as displaying different interface components according to the panel sizes of different electronic devices, or distributing a specific number of interface components to be displayed on all the electronic device in the device coordination process according to the types or the panel sizes of the electronic devices when the operating interface comprises the specific number of interface components, for which details thereof will be described later.

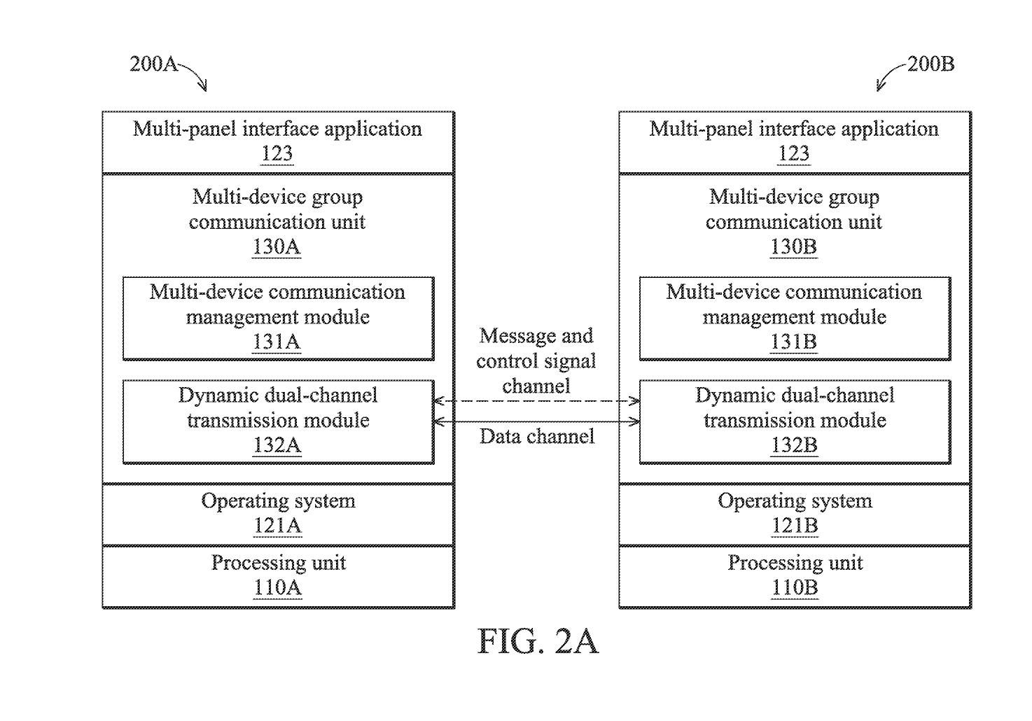

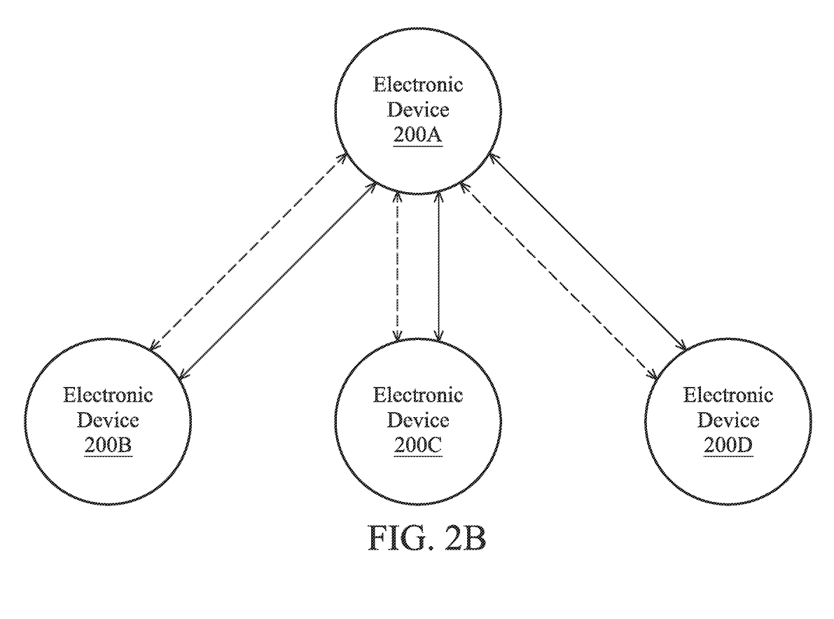

FIG. 2A illustrates a diagram of group communications between multiple electronic devices according to the third embodiment of the invention, wherein there are two electronic devices in FIG. 2A, but the invention is not limited thereto. Specifically, referring to FIG. 2A, the multi-device group communication unit 130A of the electronic device 200A may comprise the multi-device communication management module 131A and the dynamic dual-channel transmission module 132A. Each element of the electronic device 200B corresponds to the elements in the electronic device 200A, and the electronic device 200A and 200B may perform a device coordination process by using the processing unit 100A and 100B. In the embodiment, the processing unit 100A and 100B may provide the operating interface and adjust the interface elements in the operating interface by executing the multi-panel interface application 123. Briefly, the multi-device communication management modules 131A and 131B are configured to perform the device coordination process of the electronic device 200A and 200B, respectively, wherein the device coordination process indicates that different computer systems (e.g. electronic devices 200A and 200B) may build connections, and display corresponding interface elements in the operating interface, and perform data synchronization by the processing unit 100A and 100B. When the processing unit 110A in the electronic device 200A executes the multi-panel interface application 123, the processing unit 110A may communicate with other electronic devices (e.g. electronic device 200B) through the multi-device group communication unit 130A. Further, the electronic devices in the group may communicate with each other through two different channels (e.g. the first and second transmission channel), wherein the first transmission channel is a message and control signal channel, and the second transmission channel is a data channel. The message and control signal channel (i.e. the first transmission channel) is configured to transmit time-sensitive emergency messages or control signals, which have a small amount of data. The data channel (i.e. the second transmission channel) is configured to transmit common data, such as multimedia files or program files, which have a large amount of data and is less time-sensitive. The transmitted data of these two different properties will not be interfered with by each other and the transmission time will not be delayed during transmission by these two transmission channel. As illustrated in FIG. 2A, the electronic devices 200A and 200B may perform the device coordination process by the respective dynamic dual-channel transmission modules 132A and 132B. It should be noted that the electronic devices 200A and 200B may select different transmission channels to transmit data according to the data type or demand to prevent delay of time-sensitive information. In some embodiments, the message and control signal channel is built and then is kept in connection, and the data channel is built when the electronic device 200A or 200B needs to transmit the common data and is closed when the transmission of the common data is finished.

FIG. 2B illustrates a diagram of group communications between multiple electronic devices according to the fourth embodiment of the invention. In the embodiment, the multi-device communication management module 122 may dynamically select the protocol of the connection (e.g. Transmission Control Protocol (TCP) or Real Time Protocol (RTP)) according to the demand of the electronic device and the data type, and guarantee the settings of the required bandwidth during data transmission. Referring to FIG. 2B, multiple electronic devices are performing the device coordination process. If the electronic device 200A is a control terminal, the electronic devices 200B, 200C and 200D may connect to the electronic device 200A in dual channels by their own multi-device group communication unit. In another embodiment, the dynamic dual-channel transmission module 130 may support interfaces such as Wifi, 802.11x, Bluetooth, or Infrared Ray (IR), etc, and the multi-device communication management module 122 may detect whether any other corresponding electronic device exists in the local network to perform the device coordination processing. The corresponding electronic device may be an electronic device comprising the corresponding processing unit and the multi-device communication unit, such as the electronic devices 200B, 200C and 200D. After building the device coordination process, the processing unit may obtain a number of devices in the device coordination process according to the number of electronic devices in the group.

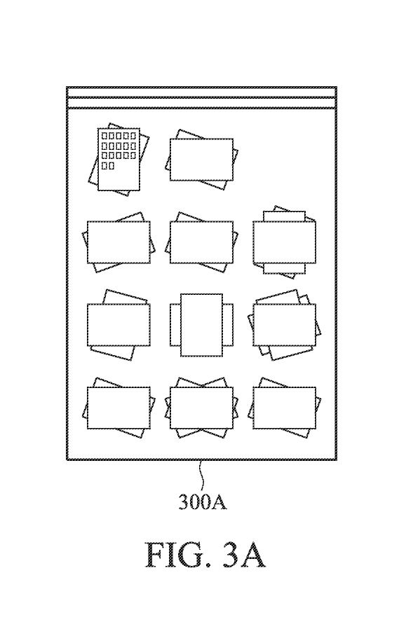

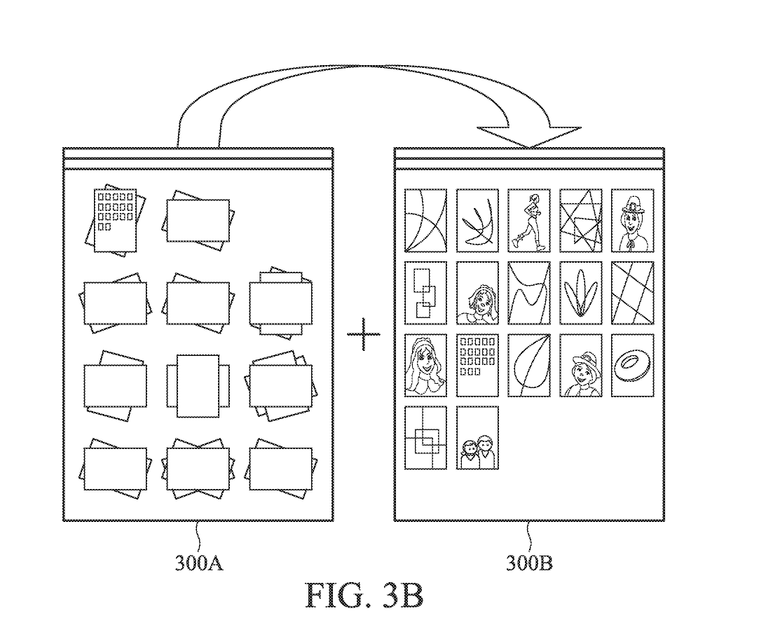

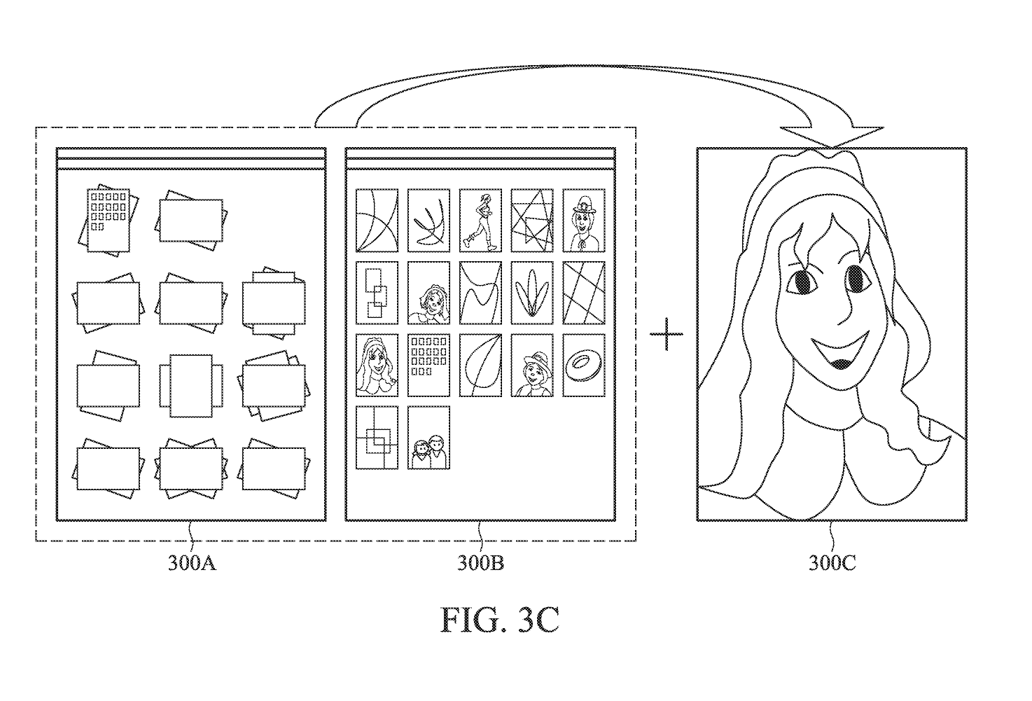

FIGS. 3A-3C illustrate diagrams of the operating interface supporting multiple panels according to the fifth embodiment of the invention. Referring to FIGS. 1A and 3A-3C, for example, when browsing pictures with a common electronic device, the user may see a plurality of classifications for pictures. The user may click to select one of the classifications, and the user may see the thumbnails of each picture in the selected picture classification. Then, the user may click to select one of the thumbnails to see the complete picture. However, if the user wants to choose other classifications of pictures, he/her has to return to the level of picture classifications to re-select another classification. The picture classifications, picture thumbnails and complete pictures are displayed by different interface components of the operating interface of the picture browsing application. The processing unit may display the different interface components, such as the picture classifications, picture thumbnails, and the complete pictures, on the electronic devices 300A, 300B and 300C, respectively.

For example, when only one electronic device 300A is used for browsing pictures, all the interface components are displayed on the electronic device 300A, wherein there is no obvious difference between the way of display and prior technologies, as illustrated in FIG. 3A. When another electronic device 300B is approaching the operating electronic device 300A, these two electronic devices 300A and 300B may perform a device coordination process and the processing units in the electronic devices 300A and 300B may display the picture classifications and the picture thumbnails on the electronic devices 300A and 300B, respectively, as illustrated in FIG. 3B. When there is yet another electronic device 300C approaching the electronic devices 300A and 300B to perform the device coordination process, the processing units in the electronic devices 300A, 300B and 300C may display the picture classifications, picture thumbnails, and the complete pictures on the electronic devices 300A, 300B, and 300C, respectively, as illustrated in FIG. 3C. It should be noted that, the electronic devices 300A, 300B and 300C may perform the multi-panel interface application 123 by their own processing unit, perform the device coordination process by their own multi-device group communication unit to display different interface components on multiple different electronic devices, perform real-time communication of operating signals between the multiple electronic devices, re-display the corresponding interface components, and synchronize data, wherein the multiple electronic devices do not simply display the multiple windows on the panels of different electronic devices, respectively. The processing unit in each electronic device may provide an operating interface, respectively, and each operating interface may display different numbers of interface components according to the number of devices in the device coordination process. When the number of devices in the device coordination process changes, the processing unit may correspondingly adjust the interface components displayed on each electronic device. For example, the electronic device 300A may originally display two interface components M and N. When the number of devices increases (e.g. adding the electronic device 300B), the interface component M is not displayed in the electronic device 300A, and is displayed on the electronic device 300B simultaneously. In another example, the interface components P, Q and R are originally displayed by the electronic devices 300A, 300B and 300C in the group, respectively. When the number of devices decreases (e.g. the electronic device 300B is removed), the interface component Q is not displayed in the electronic device 300B, and meanwhile, is display in the electronic device 300A (or 300C). Then, the electronic device 300A may simultaneously display the interface components P and Q, and the processing unit may need to adjust the display location and the display size of the interface components P and Q on the operating interface.

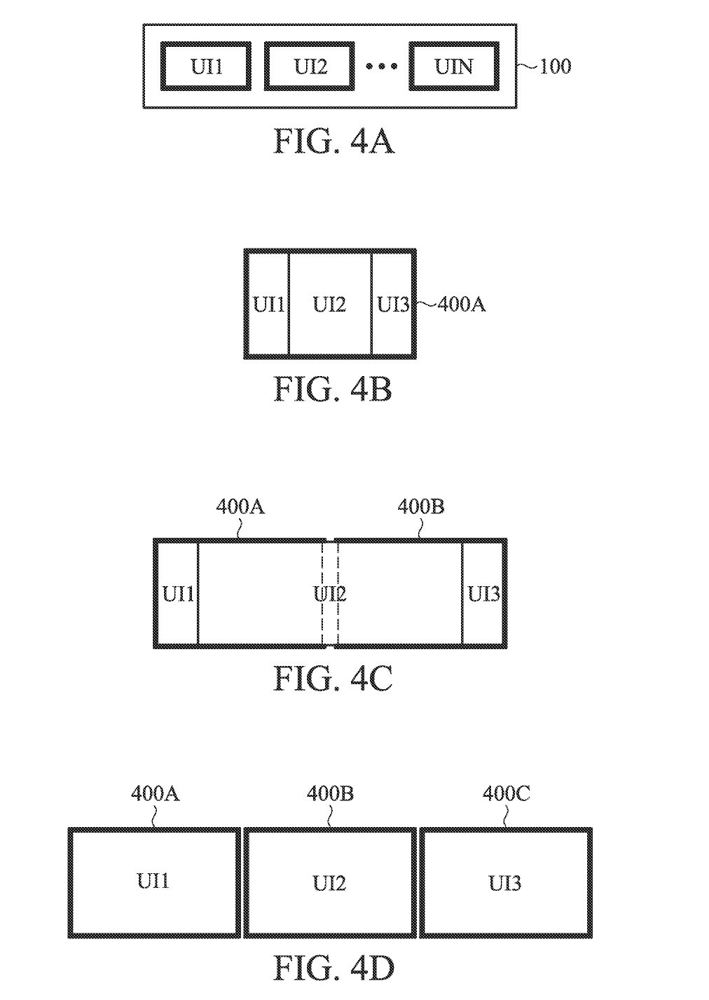

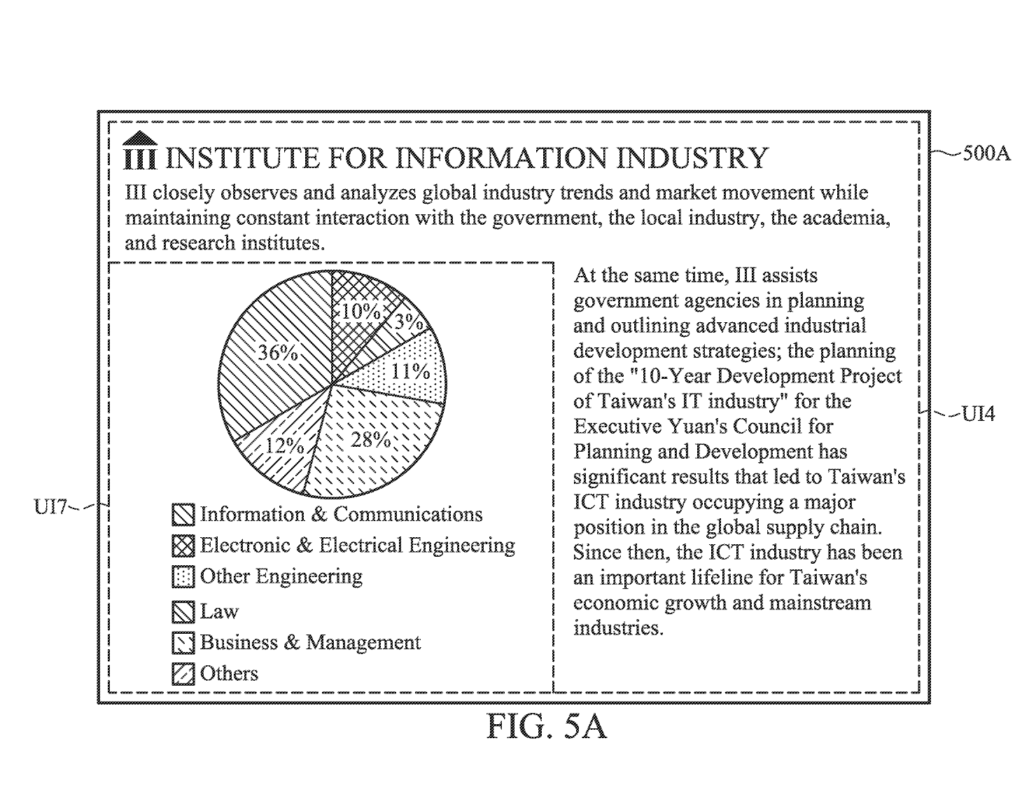

In another embodiment, the electronic device 100 may dynamically adjust the interface components displayed on each electronic device according to the number of different devices. FIGS. 4A-4D illustrate diagrams of the way of displaying the operating interface according to the sixth embodiment of the invention. As illustrated in FIG. 4A, the processing unit may provide an operating interface by executing the multi-panel interface application 123, wherein the operating interface may comprise interface components UI1˜UIN supporting different numbers of electronic devices. That is, the interface components UI1˜UIN can be assembled to build the operating interface of the multi-panel interface application 123. As illustrated in FIG. 4B, in the case of a single electronic device 400A, the processing unit may simultaneously display the components UI1˜UI3 on the electronic device 400A. As illustrated in FIG. 4C, in the case of two electronic devices 400A and 400B, the processing unit may display the interface component UI1 and half of the interface component UI2 on the electronic device 400A, and display the interface component UI3 and another half of the interface component UI2 on the electronic device 400B. As illustrated in FIG. 4D, in the case of three electronic devices 400A, 400B and 400C, the processing unit may display the interface component UI1 on the electronic device 400A, display the interface component UI2 on the electronic device 400B, and display the interface component UI3 on the electronic device 400C. In the embodiment, the operating interface in the multi-panel interface application may have a specific number of the interface components, and all the interface components are totally distributed to the electronic devices 400A, 400B and 400C. For those skilled in the art, it should be appreciated that the aforementioned embodiment merely discloses a combination of the interface components in the invention, and different numbers of electronic devices are supported in the invention. The interface components may also be displayed in different ways on each electronic device in the invention.

In another embodiment, the processing unit 11 may adjust each of the interface components to be displayed or not to be displayed in each electronic devices. That is, the adjusted interface components are displayed or not displayed by the corresponding electronic device. In other words, all of the interface components can be displayed all or partially when there is only one electronic device. When there are multiple electronic devices in the device coordination process, the processing unit may adjust each of the interface components displayed or not displayed according to the number of devices. For example, when there is only one electronic device, the display area is limited and thus some interface components can be hidden (not displayed). When there are multiple electronic devices in the device coordination process, the display area can be extended significantly, and thus the processing unit 110 may adjust each of the interface components displayed or not displayed, so that the hidden (undisplayed) interface components in a single electronic device can be displayed on the corresponding electronic device. For those skilled in the art, it should be appreciated that the aforementioned embodiment only describes a combination of the adjusted interface components, but the invention is not limited thereto.

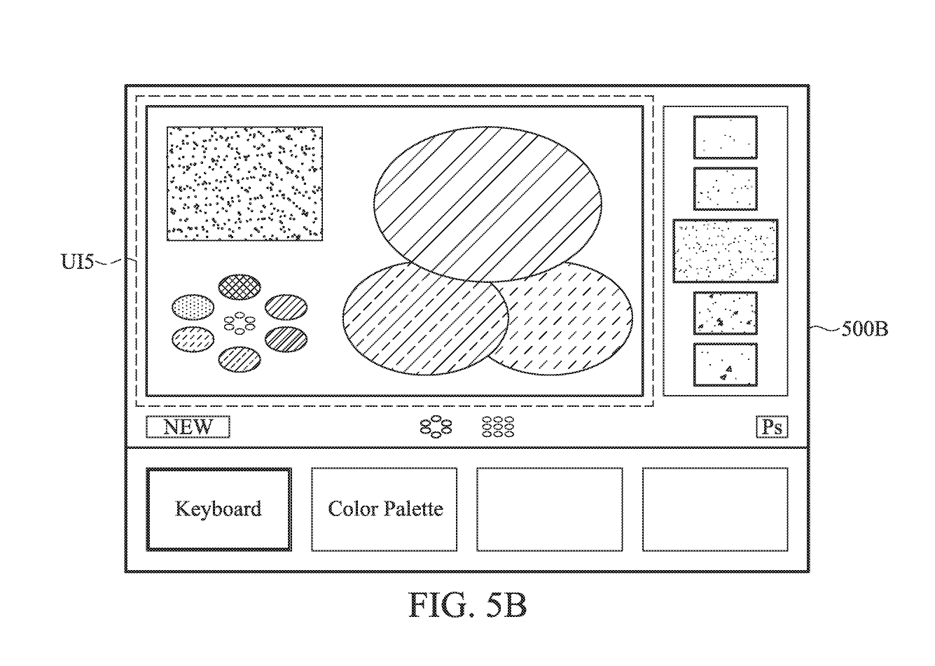

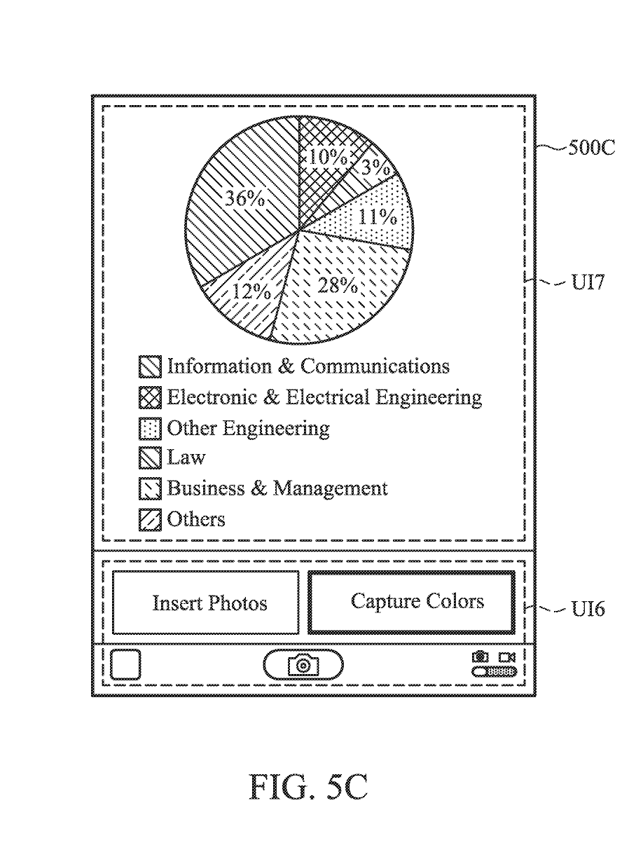

FIGS. 5A˜5C illustrate diagrams of the way of displaying the operating interface according to the seventh embodiment of the invention. As illustrated in FIG. 5A˜5C, for example, the electronic devices 500A and 500B can be tablet PCs, and the electronic device 500C can be a smart phone, wherein the multi-panel interface application 123 is installed in the electronic devices 500A˜500C and executed by the processing units thereof, respectively. In an embodiment, when the electronic device 500A executes a multi-interface text editing program (i.e. the electronic device 500A can be regarded as a control terminal in the embodiment) and performs the device coordination process with the electronic devices 500B and 500C, the electronic device 500A may display the interface components UI4 and UI7, and the electronic device 500B may display the interface component UI5, as well as the electronic device 500C may display the interface components UI6 and UI7. The interface component UI4 is a text editing area. The interface component UI5 is a text input and drawing interface. The interface component UI6 may be a color or a picture captured by the electronic device 500C. The interface component UI7 may be the editing interface of the picture in the interface component UI6. A user may utilize the electronic device 500C to capture or read a desired picture. The electronic device 500C may display the picture on the position of the interface component UI6, and transmit the picture to the electronic device 500A. The electronic device 500A may display the received picture on the position of the interface component UI6. It should be noted that the multiple electronic devices in the device coordination process not only support a multi-panel operating interface but also synchronize the data transmitted between the electronic devices. The user may further operate the executed text editing program on any interface component displayed on different electronic devices. It should be noted that, the multi-panel interface application 123 can be applied in commercial software programs, and the operating interface provided by the multi-panel interface application 123 may also be the operating interface of the commercial software. That is, the multi-panel interface application 123 can be integrated with a common commercial software program, so that the commercial software can be installed in multiple electronic devices. The user may operate the commercial software program on the multiple electronic devices simultaneously, and the usage is the same as operating in a single electronic device, where the data and display of the electronic devices can be updated synchronously.

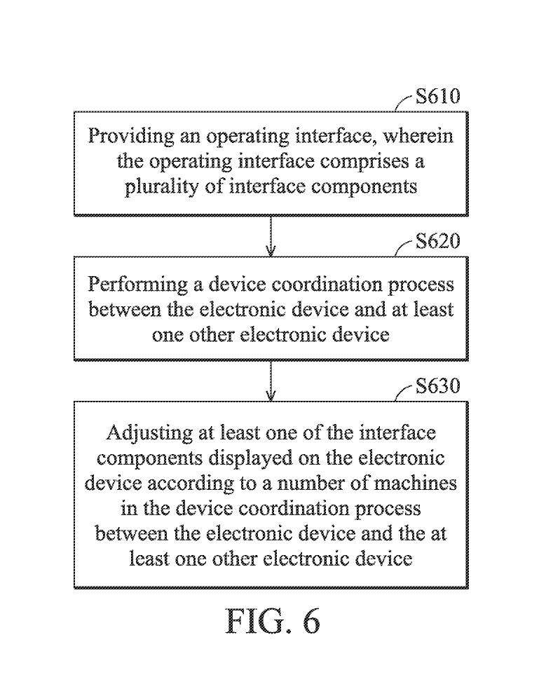

FIG. 6 illustrates a flow chart of the multi-panel interface displaying method according to an embodiment of the invention. Referring both FIG. 1A and FIG. 6, in step S610, the processing unit 110 may provide an operating interface, where the operating interface comprises a plurality of interface components. In step S620, the multi-device group communication unit 130 may perform a device coordination process between the electronic device 100 and at least one other electronic device, wherein the at least one other electronic device may have a corresponding processing unit and a corresponding multi-device group communication unit, respectively. In step S630, the processing unit 110 may adjust at least one of the interface components displayed on the electronic device 100 according to a number of devices in the device coordination process between the electronic device 100 and the as least one other electronic device (e.g. the electronic device 100A). The details and related technologies for the device coordination process between the electronic device 100 and other electronic devices, which can be referred to in aforementioned embodiments, will not be described here.

It should be noted that the electronic device and the multi-panel interface displaying method provided by the invention may utilize a combination of displays of multiple electronic devices (i.e. multiple panels), so that there is a larger flexibility for the interface design when designing applications. Further, different interface components can be set according to different combinations of multiple panels, so that the operation of the application can be more simple and fluent. Also, the multi-device group communication unit in the invention may build groups for different multiple electronic devices and help each electronic device communicate and exchange information with each other effectively, thereby achieving fast response and synchronization.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. An electronic device supporting multi-panel interface displaying, comprising:
a processing unit configured to provide an operating interface, wherein the operating interface comprises a plurality of interface components; and
a multi-device group communication unit configured to perform a device coordination process between the electronic device and at least one other electronic device, wherein the at least one other electronic device has a corresponding processing unit and a corresponding multi-device group communication unit,
wherein the processing unit adjusts at least one of the interface components displayed on the electronic device according to a number of devices in the device coordination process between the electronic device and the at least one other electronic device.

2. The electronic device as claimed in claim 1, wherein the multi-device group communication unit comprises:
a multi-device group management module configured to manage communications between the electronic device and a computer system, wherein the electronic device communicates with the at least one other electronic device through the computer system to perform the device coordination process between the electronic device and the at least one other electronic device; and
a dynamic dual-channel transmission module configured to dynamically transmit a control signal and common data from a first transmission channel and a second transmission channel, respectively.

3. The electronic device as claimed in claim 2, wherein the multi-device group management module is further configured to detect whether the computer system is located at a local network of the electronic device, wherein the processing unit connects to the at least one electronic device located at the local network of the electronic device through the computer system, and obtains the number of devices when the computer system is detected to be located at the local network of the electronic device.

4. The electronic device as claimed in claim 1, wherein types of the electronic device and the at least one other electronic device are different, wherein the processing unit further adjusts at least one of the interface components displayed on the electronic device according to the types and the number of devices when the electronic device performs the device coordination process with the at least one other electronic device.

5. The electronic device as claimed in claim 1, wherein the multi-device group communication unit is further configured to detect whether the at least one other electronic device exists in a local network of the electronic device, wherein the processing unit connects to the at least one other electronic device in the local network of the electronic device to perform the device coordination process and updates the number of devices when the at least one other electronic device is detected in the local network of the electronic device.

6. The electronic device as claimed in claim 1, wherein the processing unit is further configured to determine whether any one of the other electronic devices exits from the device coordination process, update the number of devices, and re-adjust the at least one of the interface components displayed on the electronic device according to the updated number of devices when any one of the other electronic devices exits from the device coordination process.

7. The electronic device as claimed in claim 2, wherein the at least one other electronic device connects with the electronic device through a network to perform the device coordination process, and the multi-device group management module is further configured to synchronize data generated by the corresponding operating interface between the electronic device and the at least one other electronic device.

8. The electronic device as claimed in claim 1, wherein the operating interface comprises a specific number of the interface components, and the specific number of the interface components are totally distributed to be displayed on the electronic device and the at least one other electronic device.

9. The electronic device as claimed in claim 1, wherein each one of the interface components corresponds to one of the electronic devices and the at least one other electronic device, and the processing unit is further configured to adjust each one of the interface components to be displayed or not to be displayed on the corresponding one of the electronic devices and the at least one other electronic device.

10. The electronic device as claimed in claim 1, wherein the processing unit provides the operating interface to the electronic device by executing a multi-panel interface application, and adjusts at least one of the interface components displayed on the electronic device.

11. A multi-panel interface displaying method applied in an electronic device supporting multi-panel interface displaying, comprising:
using a processor to execute the following steps of:
providing an operating interface, wherein the operating interface comprises a plurality of interface components;
performing a device coordination process between the electronic device and at least one other electronic device; and
adjusting at least one of the interface components displayed on the electronic device according to a number of devices in the device coordination process between the electronic device and the at least one other electronic device.

12. The multi-panel interface displaying method as claimed in claim 11, wherein the step of performing the group coordination of the electronic device further comprises:
managing communications between the electronic device and a computer system, wherein the electronic device communicates with the at least one other electronic device through the computer system to perform the device coordination process between the electronic device and the at least one other electronic device; and
dynamically transmitting a control signal and common data from a first transmission channel and a second transmission channel, respectively.

13. The multi-panel interface displaying method as claimed in claim 12, further comprising:
connecting the electronic device with the at least one other electronic device through the computer system located in a local network of the electronic device to perform the device coordination process, and obtaining the number of devices from the computer system when the computer system is detected in the local network of the electronic device.

14. The multi-panel interface displaying method as claimed in claim 11, wherein types of the electronic device and the at least one other electronic device are different, and the method further comprises:
adjusting at least one of the interface components displayed on the electronic device according to the types and the number of devices when the electronic device performs the device coordination process with the at least one other electronic device.

15. The multi-panel interface displaying method as claimed in claim 11, further comprising:
detecting whether the at least one other electronic device exists in a local network of the electronic device; and
connecting to the at least one other electronic device in the local network to perform the device coordination process and updating the number of devices when the at least one other electronic device exists in the local network of the electronic device.

16. The multi-panel interface displaying method as claimed in claim 11, further comprising:
determining whether any one of the other electronic devices exits from the device coordination process;
updating the number of devices when any one of the other electronic devices exits from the device coordination process; and
re-adjusting at least one of the interface components displayed on the electronic device according to the updated number of devices.

17. The multi-panel interface displaying method as claimed in claim 12, wherein the at least one other electronic device connects with the electronic device through a network to perform the device coordination process, and the method further comprises:
synchronizing the common data generated by the corresponding operating interface between the electronic device and the at least one other electronic device.

18. The multi-panel interface displaying method as claimed in claim 11, wherein the operating interface comprises a specific number of the interface components, and the specific number of the interface components are totally distributed to be displayed on the electronic device and the at least one other electronic device.

19. The multi-panel interface displaying method as claimed in claim 11, wherein each one of the interface components corresponds to one of the electronic devices and the at least one other electronic device, and the method further comprises:
adjusting each one of the interface components to be displayed or not to be displayed on the corresponding one of the electronic devices and the at least one other electronic device.

20. The multi-panel interface displaying method as claimed in claim 11, further comprising:
executing a multi-panel interface application to provide the operating interface to the electronic device; and
adjusting at least one of the interface components displayed on the electronic device.
